(19) United States
(12) Patent Application Publication
(10) Pub. No.: US 2010/0225248 A1
(43) Pub. Date: Sep. 9, 2010

(54) ILLUMINATED VISOR VANITY

(75) Inventors: William Cruickshank, Rochester Hills, MI (US); James Hobson, Hanover, MI (US); Derik Reichhart, Coldwater, MI (US); Kirk Nicola, Beverly Hills, MI (US)

Correspondence Address: BROOKS KUSHMAN P.C.;INTL. AUTOMOTIVE COMPONENTS GROUP, 1000 TOWN CENTER, TWENTY-SECOND FLOOR, SOUTHFIELD, MI, 48075, US

(73) Assignee: International Automotive Components Group North America, Inc., Dearborn, MI (US)

(21) Appl. No.: 12/399,339

(22) Filed: Mar. 6, 2009

(51) Int. Cl. H05B 37/02

(52) U.S. Cl. 315/297

(57) ABSTRACT

A visor vanity including a visor body for a vehicle having an electrical system is provided. The visor body includes a visor mirror, at least one light source, a switch, a regulator circuit and a timer. The switch causes at least one energy source that is independent of the electrical system of the vehicle to generate a first voltage signal. The regulator circuit is operably coupled to the switch and to the energy source for transmitting a second voltage signal in response to the first voltage signal so that the light source receives the second voltage signal. The timer is powered by the energy source for causing the regulator circuit to disable the operation of transmitting the second voltage signal in response to the timer achieving a predetermined count value.

### BACKGROUND

1. Technical Field

One or more embodiments of the present invention generally relate to a battery powered vanity mirror and light assembly having a regulator circuit therein for use in a vehicle.

2. Background Art

Lithium batteries are generally used for powering light emitting diodes (LEDs) in a power vanity lighting mirror. For example, such batteries may provide up to three volts to power the LEDs. The voltage may decrease to two volts the longer the battery is switched on. During periods of cold weather, the voltage output from the battery may be between two and three volts, such voltage levels may adversely affect the illumination of the LEDs.

It is generally recognized that LEDs are powered with a voltage of between 2.8 and 3.6 volts. Such an input voltage requirement varies from LED to LED. The light intensity of the LEDs may vary based on the amount of voltage used to power the LEDs within the mirror.

### SUMMARY

A visor vanity including a visor body for a vehicle having an electrical system is provided. A visor vanity including a visor body for a vehicle having an electrical system is provided. The visor body includes a visor mirror, at least one light source, a switch, a regulator circuit and a timer. The switch causes at least one energy source that is independent of the electrical system of the vehicle to generate a first voltage signal. The regulator circuit is operably coupled to the switch and to the energy source for transmitting a second voltage signal in response to the first voltage signal so that the light source receives the second voltage signal. The timer is powered by the energy source for causing the regulator circuit to disable the operation of transmitting the second voltage signal in response to the timer achieving a predetermined count value.

### BRIEF DESCRIPTION OF THE DRAWINGS

FIG. 1 is a perspective view of a visor assembly;

FIG. 1a is a partial section view of the visor taken along the line 1a-1a of FIG. 1;

FIG. 2 is a perspective view of a visor assembly;

FIG. 3 is a perspective view of the rear of an assembled vanity mirror light assembly;

FIG. 4 is an exploded view showing a first embodiment of the vanity mirror light assembly of FIG. 3;

FIG. 5 is an exploded view showing an alternative embodiment of the vanity mirror light assembly to that shown in FIG. 3;

FIG. 6a is a schematic of an example embodiment of a circuit for vanity mirror light assembly;

FIG. 6b is a schematic of an example alternative embodiment of a circuit for the vanity mirror light assembly;

FIG. 6c is a schematic of an example embodiment of a regulator circuit in accordance to one embodiment of the present invention;

FIG. 6d is a schematic of an example alternative embodiment of a regulator circuit in accordance to one embodiment of the present invention;

FIG. 6e is a schematic of an another example of embodiment of a circuit in accordance to one embodiment of the present invention; and

FIG. 7 is a diagram depicting a method for regulating voltage across a light emitting diode (LED) of the vanity mirror light assembly.

### DETAILED DESCRIPTION

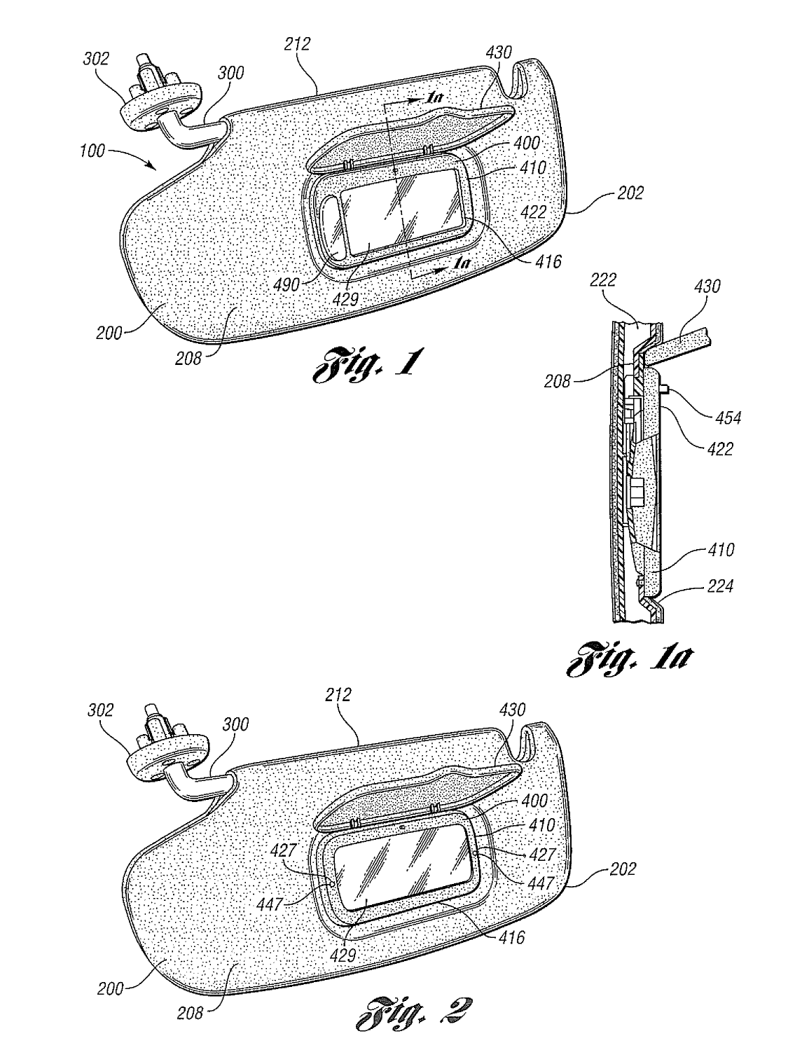

Referring to FIG. 1, a visor assembly 100 includes a visor 200 and a visor arm 300 having a visor bracket 302 of a conventional design.

The visor arm 300 is typically mounted to the visor bracket 302 which in turn may be mounted to any suitable mounting surface, such as the sheet metal of the vehicle roof (not shown). The visor arm 300 is typically pivotally connected to the visor bracket 302 such that the visor arm 300 together with the visor 200 may be moved into desired positions. For example, the visor arm 300 may typically be pivoted at the visor bracket 302 such that the visor 200 may be moved into positions such as adjacent to the front or side windows of a vehicle. Such brackets and pivotal connections are well known in the art and will not be described in further detail here.

The visor 200 is preferably mounted to the visor arm 300 via a torque control such that the visor 200 may be rotated relative to the visor arm 300. Such a torque control is preferably mounted within the visor 200 for aesthetic reasons. Any suitable type of torque control or other mechanism can be used that allows the visor 200 to be moved between, and held in, various rotational positions with respect to the visor arm 300. This allows the visor 200 to be moved between a lowered substantially vertical position or to a raised position which is substantially horizontal or higher. Such torque control arrangements are well known in the prior art and will not be described in further detail here.

As shown in FIGS. 1-4, in the visor embodiments shown, the visor 200 includes a visor body 202. The visor body 202 includes a vanity mirror light assembly 400. The vanity mirror light assembly 400 includes a vanity bezel 410, a cover 430 hingeably connected to the vanity bezel 410, a light source assembly 440, a switch 450, a timer 460, an energy source 470, and a circuit board 480.

The visor body 202 may be substantially solid or hollow and may include a substrate formed from plastic, foam, press board, or any other desired material. Any suitable visor body configuration or construction may be used with this invention. The visor body 202 in this particular embodiment is formed of a one-piece clamshell construction having a front body portion 204 and a rear body portion 206. The exterior surface 208 of the front body portion 204 and rear body portion 206 may be covered by a suitable covering 210, such as fabric, cloth, vinyl, leather, or any other suitable material or combination of materials. The front body portion 204 and rear body portion 206 may be connected by a live hinge 212 along one side.

The visor body 202 may also include a fastening mechanism such as body snaps to assist in the assembly of such a visor body 202 having a clamshell construction. Such body snaps may be of any suitable configuration such as the locking pin and socket snaps disclosed in U.S. Pat. No. 5,054,839 issued on Oct. 8, 1991 to White et al. Such snaps may have sockets or female snap receptors 216 situated at appropriate locations along the interior surface 218 of the rear body portion 206 and locking pins or male snap protrusions 220 situated at appropriate locations along the interior surface 218 of the front body portion 204 such that the male snap protrusions 220 are adjacent to, and will engage and lock into the female snap receptors 216 when the clam shell visor body 202 is closed. The interlocking of the female snap receptors 216 and male snap protrusions 220 will not only maintain such a clam shell visor body 202 in a closed position, such arrangement also serves to add structural rigidity to the visor body 202 when assembled. As shown in this embodiment, such female snap receptors 216 and male snap protrusions 220 may be integrally molded into the visor body 202 as a one-piece construction. Also, any other suitable mechanism for connecting a front body portion to a rear body portion could be used. In such a construction, or in any other suitable hollow visor body construction, the hollow space within the visor body 202 may be referred to as the visor body inner space 222.

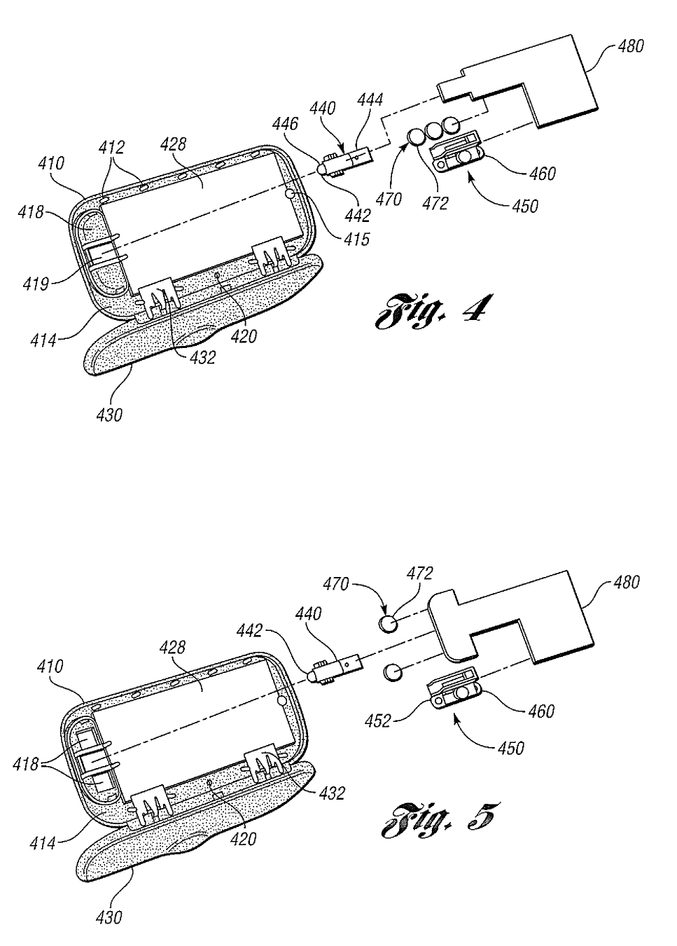

As shown in FIGS. 1, 1a, and 3, the front body portion 204 may include a body recess 224 and one or more body apertures 226 which can be of any suitable size and configuration and which are in communication with the visor body inner space 222 such that the vanity mirror light assembly 400 to be housed within the visor body 202 may be utilized. As shown in FIGS. 1 and 1a, in this embodiment the body recess 224 is dimensioned to receive the vanity mirror/light assembly 400 in an aesthetically pleasing manner.

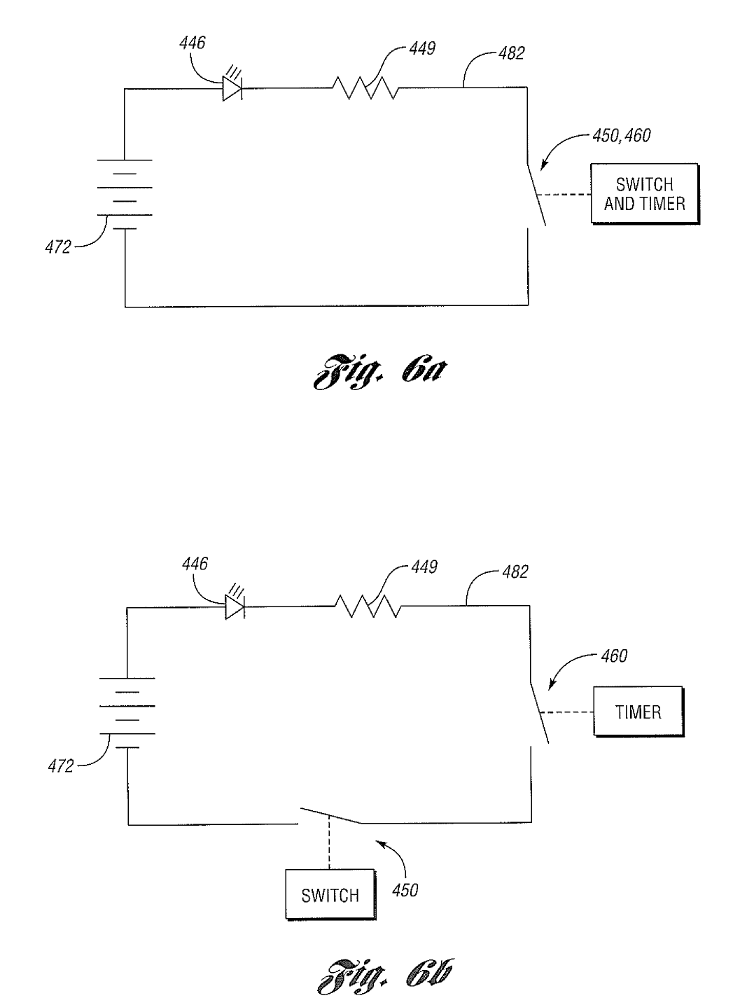

More specifically, in the embodiment shown in FIGS. 3 and 4, the vanity mirror/light assembly includes a bezel 410 having heat stake protrusions 412 located along the bezel interior surface 414 while the front body portion 204 of the visor body 202 includes heat stake apertures 228. During assembly of the visor assembly 202 of this embodiment, and before the front body portion 204 is folded over and connected to the rear body portion 206 of the visor body 202, the complete mirror/light assembly 400 is placed within the body recess 224 such that the heat stake protrusions 412 are inserted into and through the heat stake apertures 228. Then the heat staking process takes place during which the ends of the heat stake protrusions 412 are deformed such that the vanity mirror/light assembly is locked into place within the body recess 224 of the front body portion 204 of the visor body 202.

As shown in FIG. 1, the bezel 410 of the vanity mirror/light assembly 400 may have a mirror opening 416 of any suitable configuration. As shown in FIGS. 1 and 4, a mirror 428 may be mounted to the bezel interior surface 414 in any suitable manner such that the reflective surface 429 of the mirror 428 is exposed at the mirror opening 416 of the bezel 410 and available for use by a user of the vanity/mirror light assembly 400. The mirror 428 may attached to the bezel 410 in any suitable manner. Such attachment methods are known in the art. In the embodiment shown, the mirror 428 is mounted to the bezel interior surface 414 by heat staking 415.

As shown in FIG. 4, the bezel 410 of this embodiment also includes a bezel light recess 418 and bezel light recess aperture 419. A light source assembly 440 including a light source 442 and light source mount 444 may be positioned upon assembly such that the light source 442 is located within the light recess 418. The light source 442 can be any desired light source, such as a light emitting diode (LED) or incandescent light bulb. In the case of an incandescent bulb, or wherever else desired, the light source mount could include a socket such that the light source 442 could be removed and replaced if desired. LEDs are preferred because they use less energy, thereby extending the useful life of the independent energy source, such as a battery. In the embodiments shown in FIGS. 1 and 4, one LED bulb 446 has been used. However, any number of bulbs having any desired characteristics may be utilized.

In the embodiments shown in FIGS. 1, 4, 6a, and 6b, the bulb 446 is operatively mounted within the light source mount 444 which may have electrodes such that it can be operatively connected to the electrical circuit 482. The light source mounts 444 may be mounted such that the light source 442 is positioned within the light recess 418 in any suitable manner. For example, as shown in the embodiment of FIGS. 1 and 4, the light mount 444 may be mounted to the circuit board 480 in any suitable manner, such as by heat staking, snaps, or soldering for example. The latter might be especially appropriate if the light source mount 444 had electrical leads which could be operatively soldered into the circuit 482 of the circuit board 480. As another alternative, the leads to the light source 442 could be operatively soldered into the circuit 482 of the circuit board 480 without using any light source mount. Such mountings are well known in the art and will not be discussed in further detail here. Further, the light source may be operatively located and mounted in any other suitable location in any suitable manner, including by heat staking, soldering, or otherwise, such as to or within the vanity body, vanity bezel, or circuit board. Such mountings are well known in the art and will not be discussed in further detail here.

A lens 490 may be provided for diffusing the light from the light source 442 and can be attached to the visor body 202 or vanity bezel 210 in any suitable or desired manner. In the embodiment shown in FIGS. 1 and 4, the lens 490 is designed so as to be snap fitted within a light/lens opening of the bezel 410 so as to cover the underlying light source 442. Because such snap fittings or other suitable attachment methods are well known in the art, they will not be discussed in further detail here.

The cover 430 may be connected to the bezel 410 in any suitable manner such that the cover 430 may be moved from a covering to an uncovering position and vice versa. In the embodiment shown, the cover 430 is connected to the bezel 410 by way of a cam and spring hinge 432 arrangement such that the cover 430 will tend to remain in a fully covering or fully uncovering position. Such arrangements are well known in the art and will not be described in further detail here. Furthermore, while the cover 430 in these embodiments is shown to be hingeably connected to the bezel, such a cover could be hingeably connected to the visor body 202 as well. While the cover 430 is shown in these embodiments as being hingeably mounted, such a cover 430 could also be mounted so as to move in a sliding, pivoting, or any other suitable manner so as to cover and uncover the mirror as desired.

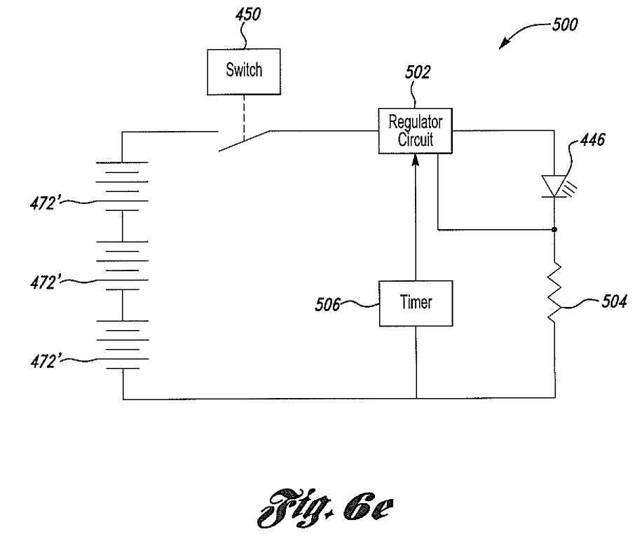

The energy source 470 of this invention is independent of the vehicle's electrical system. The energy source 470 can be any desired independent source of energy, such as one or more batteries 472. In such case, any appropriate number and capacity of batteries could be used. In the embodiment shown in FIGS. 1 and 4, the energy source 470 may comprise three 1.5V batteries in series. Any suitable batteries may be used, such as lithium type batteries. As shown in this embodiment, the batteries 472 may be attached to the circuit board 480. Such attachment can be made in any suitable manner, such as by using standard mounts for such batteries, such as battery mount clips having electrodes such that they can be operatively connected to the electric circuit 482 (e.g., see FIGS. 6a and 6b). Such attachment mechanisms are well known in the art and will not be discussed in further detail here. Note that while the energy source 470 of this embodiment is shown to be mounted to the circuit board 480, the energy source may be mounted in any suitable manner and location, such as to or within the vanity assembly, including the vanity body 202 or vanity bezel 410. For example, while not shown, the energy source could be mounted within a compartment of the vanity or visor body, with such compartment having a removable covering such that the batteries or other such independent energy source 470 could be replaced when desired.

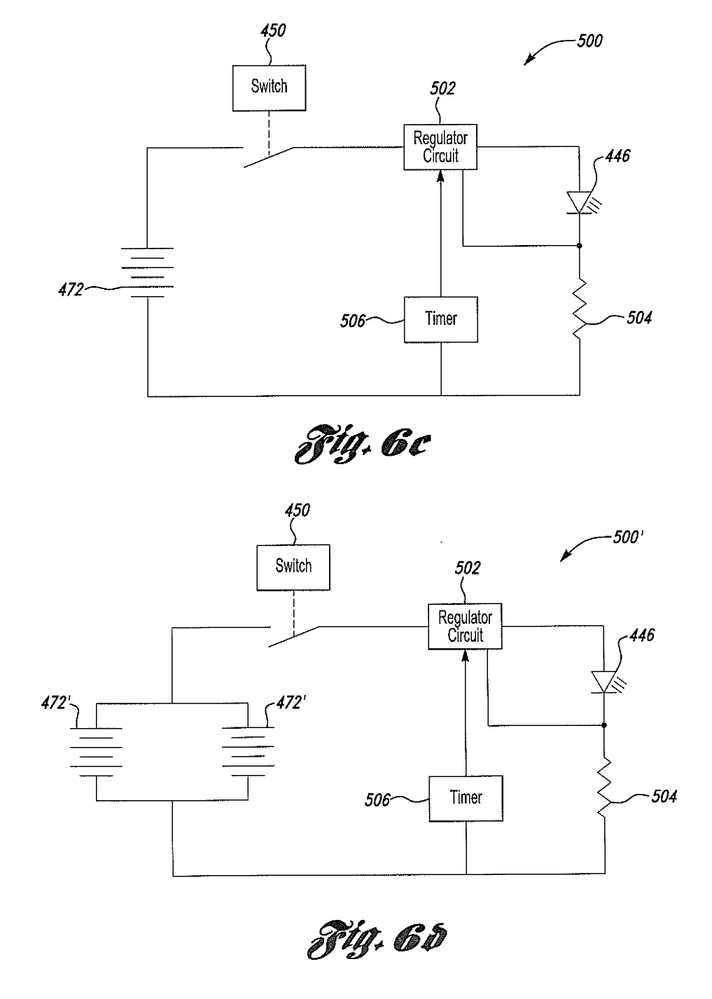

Alternatively, the energy source could be mounted within a compartment of the bezel, with such compartment having a removable covering such that the batteries or other such independent energy source 470 could be removed and replaced when desired. One possible embodiment of such an arrangement is shown in FIGS. 1 and 5, which show the use of two batteries 472 attached to the circuit board 480 such that when the vanity mirror/light assembly 400 is assembled, the batteries 472 are located within the bezel recess 418 on either side of the light source 442 under the lens 490. Such attachment of the batteries 472 to the circuit board 480 can be made in any suitable manner, such as by using standard mounts for such batteries, such as battery mount clips having electrodes such that they can be operatively connected to the electric circuit 482 (e.g., see FIGS. 6a and 6b). Such attachment mechanisms are well known in the art and will not be discussed in further detail here. In this embodiment, the lens 490 can be attached to the vanity bezel 210 in any suitable or desired manner such that it is removable so that the batteries can be removed and replaced when desired. For example, in the embodiment shown in FIGS. 1 and 5, the lens 490 may be designed so as to be snap fitted within the light/lens opening 424 of the bezel 410 so as to cover the underlying light source 442 and batteries 472. This would allow the light source 442 as well as the batteries 472 to be replaced when desired. Because such snap fittings or other suitable attachment methods are well known in the art, they will not be discussed in further detail here.

In the event a single battery 472 is implemented (e.g., 3 volt battery), the size of the entire circuit board 480 may be reduced over that shown so that the circuit board 480 is not positioned behind the mirror 428. Specifically, in such an implementation, the entire circuit board 480 may be positioned about the bezel light recess 418 and the light recess aperture 419 with no such portion of the circuit board 419 extending into a position behind the mirror 428.

In any of the embodiments, the switch 450 can have any desired configuration or can be of any desired mechanism, so long as it serves to close the circuit when the cover 430 is in an open position, such that the light source 442 is energized, and to open the circuit when the cover 430 is in a closed position, such that the light source 442 is de-energized. Any such switch used may include electrodes such that it can be operatively connected to the electrical circuit 482 (e.g., see FIGS. 6a and 6b). In the embodiment shown, the light switch 450 is a plunger switch 452 having a plunger 454 which extends through a plunger aperture 420 of the bezel 410 and beyond the bezel front face 422 such that it will be plunged or released when the cover 430 is closed or opened respectively. In the event the cover 430 is mounted so as to slide or pivot as opposed to being hinged, alternative switch arrangements, which are known in the art, may be used. In fact, even in the event the cover is hingeably connected, switches other than a plunger switch 452 may be utilized. The switch 450 may be mounted to the visor body 202, the bezel 410, the circuit board 480, or on any other suitable location and by any suitable method. The plunger switch 452 may be attached in the appropriate location to the bezel 410 by heat staking or through any other suitable mounting method. In the embodiment shown in FIG. 4, the bezel 410 is mounted to the circuit board 480 such that when the circuit board 480 is assembled with the bezel 410, the plunger switch 452 is in the appropriate location such that the plunger 454 extends through the plunger aperture 420 of the bezel 410. In such case, any suitable mounting method may be used. Because such mounting methods are well known in the art, they will not be discussed in further detail here.

The visor assembly 100 also includes a timer 460 which serves to de-energize the light source 442 after a certain time period. Such timer may have electrodes such that it can be operatively connected to the electrical circuit 482 (e.g., see FIGS. 6a and 6b). More specifically, for example, if the cover 430 is inadvertently left in an open position, the light source 442 will be de-energized after a predetermined amount of time so as to conserve or reduce usage of the energy source 420. This prevents the energy source 420, such as batteries, from being inadvertently depleted. Such a timer 460 would reset if the switch 450 were again activated by the closing and opening of the cover 430 or otherwise. The timer 460 could be a separate component interconnected with the electrical circuit 482 so as to provide the desired affect. While any suitable timer 460 could be used, the timer 460 could also be incorporated as a component of the switch 450. For example, a plunger switch 452 incorporating a timer 460 would be suitable. Such a timer could be operatively mounted to the visor body 202, the bezel 210, the circuit board 480, or on any other suitable location and by any suitable mounting method. For example, the leads of such a timer 460 could be operatively soldered into the circuit 482 of the circuit board 480. Because such mounting methods are well known in the art, they will not be discussed in further detail here.

The circuit board 480 may be of any suitable configuration and may include any desired electrical components and an electrical circuit 482 (e.g., see FIGS. 6a and 6b). Any circuit 482 may be configured to include the energy source 420, switch 450, timer 460, and light source 442 (e.g., LED 446) such that, when the cover 430 is opened and the switch 450 is closed, the light source 442 will be energized; such that when the cover 430 is closed and the switch 450 is opened, the light source 442 will be de-energized; and such that, if the cover 430 is opened for a certain period of time the timer 460 will operate to de-energize the light source, thereby conserving the life of both the energy source 420 and the light source 442.

Furthermore, while not shown in these embodiments, the visor assembly 100 could include a switch operated by the user of the vanity mirror instead of the cover 430. Alternatively, the visor assembly 100 could include a user switch such that if it were desired to energize the light source 442 for a length of time beyond that of the timer 460, the user could engage such a user switch to do so. Such switch alternatives could be operatively part of the electric circuit 482 and any such user switches could be located at the bezel front face 422.

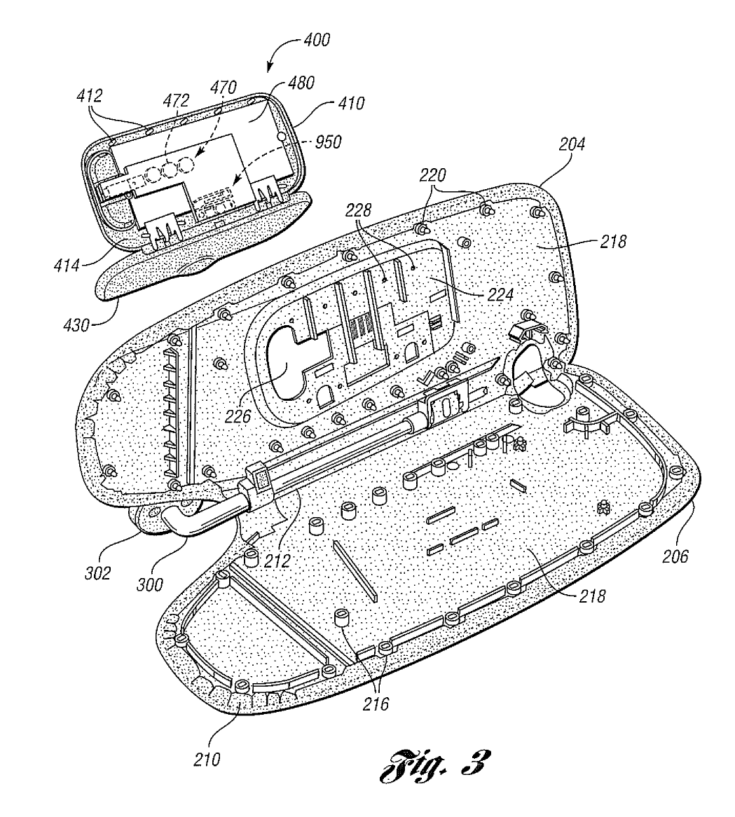

FIG. 2 discloses another one of many possible alternative embodiments of the invention. In this embodiment as shown, in lieu of a light source assembly 440 underlying a lens 490 within a bezel light recess 418, the bezel includes LED openings 427 through which two LEDs 447 protrude. No lens is required. The LEDs may be mounted to the circuit board or to the bezel in any suitable manner. Of course, and light source other than LEDs could also be used. In the event LEDs are used, any appropriate LEDs may be used. Two 3 mm yellowish white LED bulbs having a forward voltage between 2.8 and 4.0V may be suitable. However, any number of bulbs having any desired characteristics may be utilized.

FIG. 6a is a simplified schematic of one of many possible circuits 482 which may be used when the timer 460 is incorporated as a component of the switch 450 such as described above. The circuit could include other components as desired. The switch could be a cover activated switch, a user activated switch, or otherwise. Other elements of the circuit 482 in this sample embodiment are the LED 446, a resistor 449, and the battery energy source 472.

FIG. 6b shows a simplified schematic of an alternative possible circuit 482 with a timer 460 in the form of a switch being a separate component from the light switch 450. Again, the light switch could be a cover activated switch, a user activated switch, or otherwise.

FIG. 6c is a schematic of an example embodiment of a circuit 500 in accordance to one embodiment of the present invention. The circuit 500 may be used as an alternative circuit in place of the circuits depicted in FIGS. 6a and 6b. The circuit 500 comprises the LED 446, the switch 450, the battery energy source 472, a regulator circuit 502, a resistor 504, and a timer 506. In general, the battery energy source 472 is generally capable of providing up to three volts for powering the LED 446. The LED 446 on the other hand generally needs a supply voltage within a predefined voltage range of 3.0 to 3.5 volts to illuminate. To compensate for the possible 0.5 voltage shortfall from what the battery energy source 472 is capable of providing, the regulator circuit 502 may increase the amount of voltage provided to the LED 446. In one example, the regulator circuit 502 may be the ZXSC400 boost circuit as produced by Zetex Semiconductors®.

In operation, as the user opens the cover 430 to the open position, the switch 450 closes thereby allowing the battery energy source 472 to provide voltage to power the regulator circuit 502. The regulator circuit 502 generally requires an input voltage of between one and eight volts. The regulator circuit 502 provides an output voltage for powering the LED 446 in response to the voltage provided by the battery energy source 472. The resistor 504 is positioned in series with the LED 446. The regulator circuit 502 measures voltage across the resistor 504 and uses such a measured voltage as feedback for determining whether the LED 446 is receiving a voltage within the predefined voltage range of between 3.0 to 3.5 volts.

For example, the regulator circuit 502 generally includes a predetermined voltage value stored therein that corresponds to a predetermined voltage drop across the resistor 504. The predetermined voltage drop across the resistor 504 is indicative of the amount of current flowing through the LED 446. In one example, the predetermined voltage value may correspond to a value of approximately 0.3 volts. The predetermined voltage value may vary accordingly based on the size of the resistor and on the particular current requirements of the LED 446 that is needed to allow the LED 446 to illuminate as desired. The regulator circuit 502 compares the measured voltage across the resistor 504 to the predetermined voltage value to determine the amount of current to provide to the LED 446.

The regulator circuit 502 is generally configured to provide the same amount or more voltage than that is capable of being provided by the battery energy source 472. The regulator circuit 502 is generally configured to hold the current constant across the LED 446 by continually monitoring and comparing the voltage across the resistor 504 to the predetermined voltage value and adjusting the voltage output in response thereto. While not shown, it is generally contemplated that additional LEDs may be added to the circuit 500 so that such additional LEDs may receive the same voltage output from the regulator circuit 500. By ensuring that the LED 446 and any additional LEDs positioned within the vanity mirror and light assembly receives a constant current, the LED 446 and the additional LEDs (not shown) may provide a similar light output from one another through all voltage variations.

The timer 506 is generally enabled to begin a count sequence in response to the switch 450 being closed. The timer 506 may be set to open the circuit 500 upon achieving a predetermined count value. In one example, the predetermined count value may correspond to 90 seconds. The length of the predetermined count value may affect the life of the battery energy source 472. As such, a larger predetermined count value may adversely impact the life span of the battery energy source 472. In most cases, automotive Original Equipment Manufactures (OEMs) may require that the life span of the battery energy source 472 achieve a ten year life span. Due to such a requirement, it is generally contemplated that the predetermined count value may correspond to a value between 30 to 240 sec. The timer 506 may be implemented as Part Number MC14541B as produced by ON Semiconductor®. In response to the timer 506 achieving the predetermined count value, the timer 506 may transmit a control signal to the regulator circuit 502 so that the regulator circuit 502 may discontinue providing voltage to the LED 446.

FIG. 6d is a schematic of an example alternative embodiment of the circuit 500 in accordance to one embodiment of the present invention. Circuit 500′ includes a plurality of battery energy sources 472′ coupled in a parallel configuration. Multiple battery energy sources 472′ may be implemented in order to achieve the OEM desired life span. For example, the battery energy source 472 as noted in connection with FIG. 6c may provide 550 mAh. The plurality of battery energy sources 472′ as depicted in circuit 500′ may provide for 1100 mAh and a total voltage output of 3.0 volts. In such a case, the regulator circuit 502 may increase the amount of voltage that is provided by the plurality of energy sources 472′ to provide the desired amount of voltage to the LED 446.

FIG. 6e is a schematic of an example alternative embodiment of the circuit 500 in accordance to one embodiment of the present invention. Circuit 500″ resembles that of circuit 500′ with the exception of the plurality of battery energy sources 472′ being shown in a series configuration. Such a battery arrangement may also achieve the OEM desired life span. Each energy source 472′ may provide up to 1.5 volts. The battery energy sources 472′ as depicted in FIG. 6e may provide a total of 4.5 volts. As such, the regulator circuit 502 may be configured to reduce the amount of voltage provided to the LED 446 from the battery energy sources 472′. As noted above, the regulator circuit 502 generally requires an input voltage of between one and eight volts. In the event the regulator circuit 502 receives 4.5 volts from the battery energy sources 472′, the regulator circuit 502 may step down the voltage and transmit the desired voltage to drive the LED 446 to achieve the desired illumination. The regulator circuit 502 may measure the voltage across the resistor 504 and compare the measured voltage across the resistor 504 to the predetermined voltage value to ensure that the current delivered to the LED 446 is at the desired level.

As the voltage generating capabilities of the battery energy sources 472′ decrease over time, the regulator circuit 502 may step up or boost the voltage provided to the LED 446. For example, in the event the plurality of battery energy sources 472′ provide a voltage of 3 volts or less to the regulator circuit 502, the regulator circuit 502 may provide a voltage output that is higher than the 3 volts to power the LED 446 in the event such an increase in voltage is needed to achieve the desired illumination. In one example, the regulator circuit 502 that is capable of either boosting input voltage or decreasing input voltage may be the TPS61130, TPS61131, or TPS61132 buck/boost DC/DC converter circuit as produced by Texas Instruments®. It is generally contemplated that the regulator circuits as discussed in connection with FIGS. 6c-6d may also be implemented as a buck/boost DC/DC converter. The timer 506 may operate in the same manner as described in connection with FIG. 6c.

The battery energy source 472 as noted in connection with FIG. 6c and the plurality of battery energy sources 472′ as noted in connection with FIGS. 6d-6e are independent from the vehicle's electrical system and are generally lithium batteries. In one example, each battery energy source 472 and 472′ may be implemented as a CR2450HR battery.

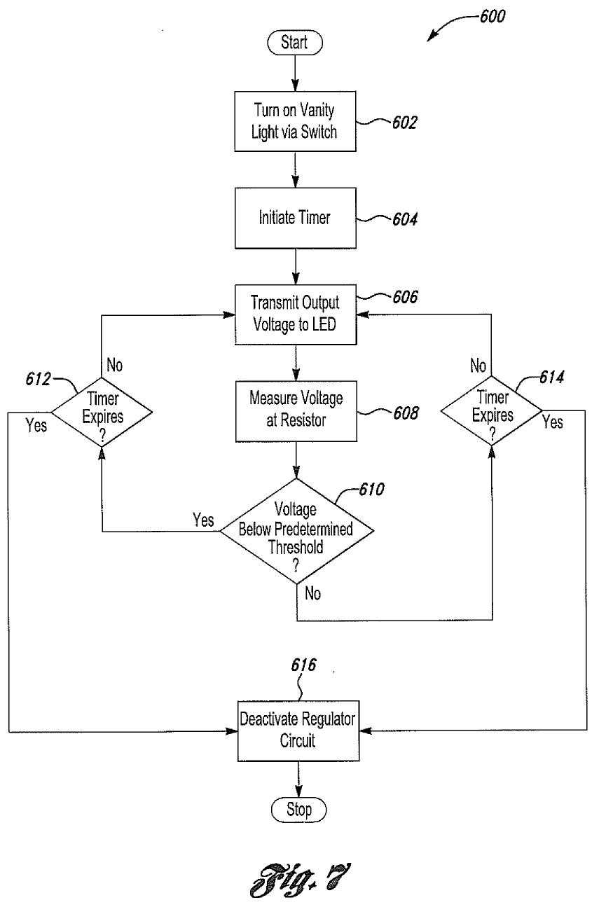

FIG. 7 is a diagram depicting a method 600 for regulating energy across the LED 446 of the vanity mirror light assembly.

In operation 602, a user opens the cover 430 to the open position, the switch 450 closes allowing the battery energy source(s) 472 (and/or 472′) to power the regulator circuit 502.

In operation 604, the timer 506 begins counting in response to the switch 450 closing.

In operation 606, the regulator circuit 502 receives voltage from the battery energy source 472 (or plurality of battery energy sources 472′) and transmits an output voltage to the LED 446.

In operation 608, the regulator circuit 502 measures the voltage drop the resistor 504 to assess whether the output voltage needs to be adjusted.

In operation 610, the regulator circuit 502 compares the measured voltage drop across the resistor 504 to the predetermined voltage value. If the measured voltage drop is less than the predetermined voltage value, then the method 600 moves to operation 612. If the measured voltage drop is greater than the predetermined voltage value, then the method 600 moves to operation 614.

In operation 612, the timer 506 determines whether the count sequence has expired. If the count sequence has expired, then the method 600 moves to operation 616. If the count sequence has not expired, then the method 600 moves to operation 606. In operation 606, the regulator circuit 502 increases the amount of voltage delivered to the LED 446.

In operation 614, the timer 506 determines whether the count sequence has expired. If the count sequence has expired, then the method 600 moves to operation 616. If the count sequence has not expired, then the method 600 moves to operation 606. In operation 606, the regulator circuit 502 decreases the amount of voltage delivered to the LED 446.

In operation 616, the timer 506 transmits the control signal to the regulator circuit 502 so that the regulator circuit 502 discontinues providing voltage (or current) to the LED 446.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A visor vanity for a vehicle having an electrical system, the visor vanity comprising:
a visor body including:
a vanity mirror;
at least one light source;
a switch for causing at least one energy source that is independent of the electrical system of the vehicle to generate a first voltage signal;
a regulator circuit operably coupled to the switch for transmitting a second voltage signal in response to the first voltage signal so that the at least one light source receives the second voltage signal; and
a timer powered by the at least one energy source for causing the regulator circuit to disable the operation of transmitting the second voltage signal in response to the timer achieving a predetermined count value after transmission of the second voltage signal.

2. The visor vanity of claim 1 wherein the visor body further comprises a resistor operably coupled to the at least one light source for receiving a portion of the second voltage signal from the at least one light source.

3. The visor vanity of claim 2 wherein the regulator circuit is configured to measure a portion of the second voltage signal across the resistor for comparison to a predetermined voltage value.

4. The visor vanity of claim 3 wherein the regulator circuit is configured to adjust the second voltage signal based on the comparison of the measured portion of the second voltage signal to the predetermined voltage value.

5. The visor vanity of claim 4 wherein the regulator circuit is configured to increase the second voltage signal in response to determining that the measured portion of the second voltage signal is below the predetermined voltage value.

6. The visor vanity of claim 5 wherein the regulator circuit is configured to decrease the second voltage signal in response to determining that the measured portion of the second voltage signal is greater than the predetermined voltage value.

7. The visor vanity of claim 1 wherein the predetermined count value is in the range of between 30 and 240 seconds.

8. The visor vanity of claim 1 wherein visor body further includes a removable lens overlying at least one of the light source and the energy source such that the at least one of light source and the energy source is capable of being accessed and replaced by removing the removable lens.

9. A visor vanity for a vehicle having an electrical system, the visor vanity comprising:
a visor body including:
a vanity mirror;
at least one light source;
at least one energy source being independent of the electrical system of the vehicle for generating a first voltage signal;
a switch for causing the at least one energy source to generate the first voltage signal;
a regulator circuit operably coupled to the switch and to the at least one energy source for transmitting a second voltage signal in response to the first voltage signal so that the at least one light source receives the second voltage signal to illuminate, wherein the first voltage signal is greater than the second voltage signal; and
a timer powered by the at least one energy source for causing the regulator circuit to disable the operation of transmitting the second voltage signal in response to the timer achieving a predetermined count value.

10. The visor vanity of claim 9 wherein the visor body further comprises a resistor operably coupled to the at least one light source for receiving a portion of the second voltage signal from the at least one light source.

11. The visor vanity of claim 10 wherein the regulator circuit includes a predetermined voltage value stored therein and the regulator circuit is configured to measure the portion of the second voltage signal across the resistor for comparison to the predetermined voltage value.

12. The visor vanity of claim 11 wherein the regulator circuit is configured to increase the second voltage signal in response to determining that the measured portion of the second voltage signal is below the predetermined voltage value and to decrease the second voltage signal in response to determining that the measured portion of the second voltage signal is greater than the predetermined voltage value.

13. The visor vanity of claim 9 wherein the predetermined count value is in the range of between 30 and 240 seconds.

14. The visor vanity of claim 9 wherein the visor body further includes a removable lens overlying at least one of the light source and the energy source such that the at least one of the light source and the energy source is capable of being accessed and replaced by removing the removable lens.

15. A visor vanity for a vehicle having an electrical system, the visor vanity comprising:
a visor body including:
a vanity mirror;
at least one light source;
an energy source being independent of the electrical system of the vehicle for generating a first voltage signal;
a switch for causing the at least one energy source to generate the first voltage signal;
a regulator circuit operably coupled to the switch and to the at least one energy source for transmitting a second voltage signal in response to the first voltage signal so that the at least one light source receives the second voltage signal to illuminate, wherein the first voltage signal is less than the second voltage signal; and
a timer powered by the at least one energy source for causing the regulator circuit to disable the operation of transmitting the second voltage signal in response to the timer achieving a predetermined count value.

16. The visor vanity of claim 15 further comprising a resistor operably coupled to the at least one light source for receiving a portion of the second voltage signal from the at least one light source.

17. The visor vanity of claim 16 wherein the regulator circuit includes a predetermined voltage value stored therein and the regulator circuit is configured to measure the portion of the second voltage signal across the resistor for comparison to the predetermined voltage value.

18. The visor vanity of claim 17 wherein the regulator circuit is configured to increase the second voltage signal in response to determining that the measured portion of the second voltage signal is below the predetermined voltage value and to decrease the second voltage signal in response to determining that the measured portion of the second voltage signal is above the predetermined voltage value.

19. The visor vanity of claim 15 wherein the predetermined count value is in the range of between 30 and 240 seconds.

20. The visor vanity of claim 15 wherein the visor body further includes a removable lens overlying the at least one of the light source and the energy source such that the at least one of the light source and the energy source is capable of being accessed and replaced by removing the removable lens.
